(19) United States
(12) Patent Application Publication
(10) Pub. No.: US 2021/0071387 A1
(43) Pub. Date: Mar. 11, 2021

(54) CUTTING COMPONENT WITH FASTENING PORTION

(71) Applicant: Caterpillar Inc., Peoria, IL (US)

(72) Inventors: Tobias J. Toennies, Metamora, IL (US); David Bruno Parzynski, JR., Peoria, IL (US)

(73) Assignee: Caterpillar Inc., Peoria, IL (US)

(21) Appl. No.: 16/566,376

(22) Filed: Sep. 10, 2019

(51) Int. Cl. E02F 3/815; A01B 15/08; E02F 9/28

(52) U.S. Cl. CPC E02F 3/8152; E02F 9/2833; A01B 15/08

(57) ABSTRACT

A cutting component for a machine including a moldboard with a first end and an adapter plate with an adapter slot mounted to the moldboard proximate the first end. The cutting component can include body portion and a fastening portion that extends from the body portion. The fastener portion is shaped to slidably mate with the adapter slot of the adapter plate. The fastening portion can be shaped with a first portion located at the interface between the body portion and the fastening portion, and a second portion located further from the body portion than the first portion and shaped wider than the first portion. The difference in width between the first portion and second portion, allows the cutting component engage with the adapter plate from within in the adapter slot and resist to resist working loads with material during operation of the machine.

### TECHNICAL FIELD

The present disclosure generally pertains to ground engaging machines. More particularly this disclosure is directed toward a cutting component with a fastening portion for ground engaging machines.

### BACKGROUND

Earth moving equipment such as scrapers, dozers, dragline buckets, backhoes, shovel dippers, and the like are generally provided with a cutting component which is adapted to engage and displace earth. Because the main digging unit, for example the bucket of a dozer blade is relatively expensive, it is desirable to provide a replaceable cutting component so that the main digging unit can be maintained relatively sharp without having to rework the entire bucket. The cutting component must be securely mounted, however, to withstand the considerable forces which are exerted thereon during digging or scraping, and suitable securement is generally obtained only by sacrificing some degree of removability.

U.S. Pat. No. 3,685,177 to Hahn et. al. describes a two part cutting edge structure for an earth moving unit including a first part or an adapter part which is adapted to be removably secured to the earth moving unit and a second or cutting edge part which is adapted to be removably secured to the first part. Each of the parts is generally elongated and includes a longitudinally extending, generally flat bearing surface arranged in side-by-side relation, and the other longitudinal edge of the second part provides a cutting edge. The adapter part is provided with two or more spaced apart sockets having upper and lower walls, and the cutting edge part includes rearwardly extending tab arms which are received in the socket and are engageable with the upper and lower socket walls to prevent rotation of the cutting edge part about the adapter part. The abutting bearing surfaces of the two parts provide resistance against thrust loading on the cutting edge part, and the tab arms and sockets provide resistance against beam loading on the cutting edge part.

The present disclosure is directed toward overcoming one or more of the problems discovered by the inventors or that are known in the art.

### SUMMARY

A cutting component for a machine including a moldboard with a first end, and an adapter plate with an adapter slot mounted to the moldboard proximate the first end is disclosed herein. The cutting component includes a body and a fastener. The body includes a cutting portion configured to engage a working material. The fastener extends from the body and extends longitudinally along the body. The fastener is shaped to slidably mate with the adapter slot of the adapter plate. The fastener includes an upper portion located at the interface between the body portion and the fastener, and a lower portion located further from the body portion than the first portion. The second portion shaped wider than the first portion with respect to a direction that is perpendicular to the longitudinal direction of the fastener.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is an illustration of a an exemplary ground engaging machine;

FIG. 2 is a perspective view of an adapter plate attached to the moldboard from FIG. 1;

FIG. 3 is a different perspective view of the adapter plate and the moldboard from FIG. 2;

FIG. 4 is a bottom perspective view of an exemplary cutting component;

FIG. 5 is an end view of the exemplary cutting component shown in FIG. 4;

FIG. 6 is a perspective view of the cutting component of FIG. 4 mated with the adapter plate of FIGS. 2 and 3;

FIG. 7 is an elevation view of the cutting component mated with the adapter plate from FIG. 6;

FIG. 8 is a side view of another cutting component;

FIG. 9 is a back view of the cutting component from FIG. 8; and

FIG. 10 is a perspective view of the cutting component of FIG. 8 mated with the adapter plate of FIGS. 2 and 3; and

FIG. 11 is a side view of the cutting component of FIG. 8 mated with the adapter plate of FIGS. 2 and 3.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent that those skilled in the art will be able to understand the disclosure without these specific details. In some instances, well-known structures and components are shown in simplified form for brevity of description. Furthermore, some of the features and surfaces have been left out or exaggerated for clarity and ease of explanation.

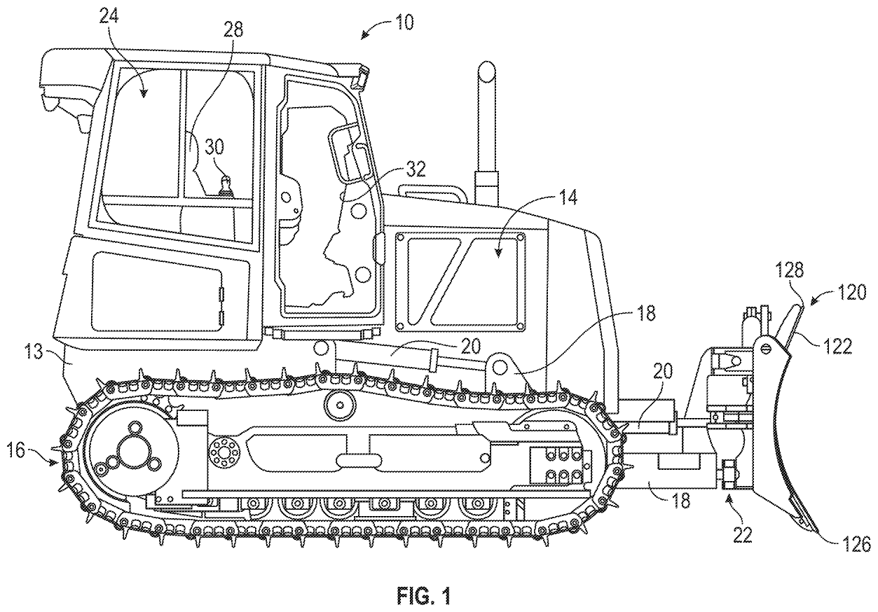

FIG. 1 is an illustration of a machine. The machine 10, also referred to as a ground engaging machine, discussed in this disclosure is generally known as a track-type tractor. However, it should be readily understood by those having ordinary skill in the art that the systems of the present disclosure can be used on other machines such as motor graders, wheel dozers, track-type loaders, skid steer loaders, multi-terrain loaders, compact track loaders, track loaders, wheel loaders, wheel-tractor scrapers, as well as other machines. As should also be understood, such machines may be used in materials handling, construction, and other industries. Machine 10 includes a moldboard 120, having a cutting component, such as a dozing-type blade, for moving working materials such as soil, rock, sand, garbage, brush, and any other movable material.

Machine 10 includes a frame 13, a power system 14, and a propulsion system 16. The frame 13 may take many different forms as will be recognized by those having ordinary skill in this art. For example, the frame 13 may be a rigid frame, a flexible frame, an articulating frame, or any other type of frame/frame assembly capable of supporting machine 10. In addition, it should be readily understood that the frame 13 may be configured to mate with a machine undercarriage system (as shown with the propulsion system 16 of the track-type tractor in FIG. 1).

The power system 14 may include an engine such as, a diesel engine, a gasoline engine, a gaseous fuel-powered engine or any other type of combustion engine. It is contemplated that power system 14 may alternatively embody a non-combustion source of power such as a fuel cell, a power storage device, or any other type of power source. Power system 14 produces a mechanical or electrical power output that is then converted to mechanical, hydraulic, electrical, and/or other power for operating machine 10.

The propulsion system 16 includes a track-drive system incorporated with the machine undercarriage. In an alternative embodiment, the propulsion system 16 may include a wheel-drive system, or any other type of drive system to propel the machine 10. The propulsion system 16 may also include a transmission, a fluid pump (e.g., hydraulic system), and/or other devices to convert energy from the power system 14 to propel the machine 10 using the propulsion system 16. The propulsion system 16, including the undercarriage, is configured to receive power from the power system 14 and to convert that power to movement to propel the machine 10.

The machine 10 may further include one or more lift arms 18 pivotably coupled to the machine 10. One or more hydraulic cylinders 20 are operatively coupled between the frame 13 and the lift arms 18 to raise, lower, pivot, or otherwise manipulate the lift arms 18 and the moldboard 120. A hydraulic system (not shown) utilizes power from the power system 14 to generate pressurized fluid to operate the hydraulic system (including the hydraulic cylinders 20).

A coupler 22 may be coupled to the lift arms 18. The coupler 22 is configured to selectively attach to a work tool, as shown in FIG. 1. Construction and operation of the lift arms 18, hydraulic cylinder 20, and coupler 22 should be understood by those having ordinary skill in the art.

Machine 10 further includes an operator station 24 supported by the frame 13. The operator station 24 is configured to hold an operator of the machine 10, and includes control devices configured to allow the operator to control operations of the machine 10 from the operator station 24. The operator station 24 may be open or may be enclosed within a cab, as desired.

The operator station 24 includes a seat 28, one or more operator interface device(s) 30 and one or more control panel(s) 32. The seat 28 is operatively coupled to the frame 13 and is configured to support the operator during operation of the machine 10. An operator interface device 30, such as a joystick, steering wheel, lever, knob, button, switch, and/or a variety of other interface devices receive input, such as motion, pressure, and etc., from the operator and communicate that input for controlling operation of the machine 10.

In operation, the operator sits in the seat 28 and manipulates one or more operator interface device(s) 30 (e.g., configured as joysticks having buttons, switches, and/or knobs), which causes the machine 10 to travel using the propulsion system 16 powered by the power system 14. In addition, manipulation of the operator interface device(s) 30 may cause the hydraulic system to operate the hydraulic cylinder(s) 20, which pivots the lift arm(s) 18, with respect to the frame 13 of the machine 10 to raise, lower, and/or pivot the moldboard 120.

The moldboard 120 can be configured to mount to machine 10. The moldboard 120 can be configured to engage, dig, or otherwise receive material, such as soil, rock, gravel, and/or other materials (not shown) to be moved by machine 10. The moldboard 120 is formed of a rigid material, such as steel, iron, or other material and has a front side 122, first end 126 and a second end 128 opposite the first end 126. Thus, the front side 122 receives and moves material when the first end 126 is lowered to a position to engage the material and when machine 10 is traveling generally in a forward direction. To efficiently move the material, the moldboard 120 can be generally formed having an arcuate profile shape, Such arc or radius shape allows the moldboard 120 to engage, push, and roll the material as the material moves up the moldboard 120 and tumbles forward while machine 10 moves in the forward direction. However, it is contemplated that the profile shape of the moldboard 120 may be other shapes.

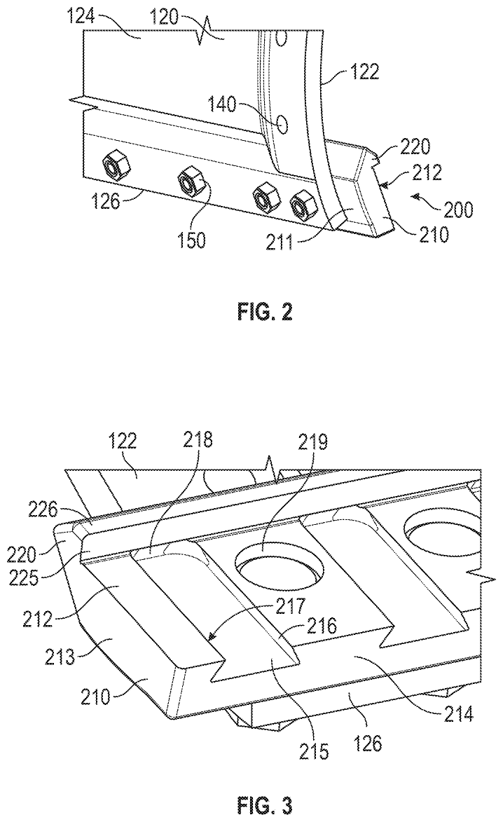

FIG. 2 is a perspective view of an adapter plate attached to the moldboard from FIG. 1. Where the drawing includes multiple instances of the same feature, for example mounting fasteners 150, the reference number is only shown in connection with one instance of the feature to improve the clarity and readability of the drawing. This also true in other drawings which include multiple instances of the same feature. An adapter plate 200 can comprise a front portion 210 and a back portion 220 extending from the front portion 210. The front portion 210 can have a bottom surface 211 configured to contact the front side 122 of the moldboard 120, proximate to the first end 126. The front portion 210 can have an upper surface 212 that is opposite the from the bottom surface 211. The moldboard 120 can have mounting holes 140 for receiving mounting fasteners 150.

FIG. 3 is a different perspective view of the adapter plate and the moldboard from FIG. 2. The front portion 210 of the adapter plate can have a front surface 214 that is opposite from the back portion 220. The upper surface 212 can intersect with the front surface 214 and extend to the intersection of the front portion 210 and the back portion 220.

The back portion 220 can have a top surface 226 that is located opposite from the bottom surface 211 of the front portion 210. The back portion 220 can have a shoulder surface 225 that intersects with the top surface 226 and extends to the upper surface 212 of the front portion 210.

The front portion 210 can have adapter slots 230 having a dovetail shaped cross-section that is open through the upper surface 212 and extends from the front surface 214 towards the back portion 220. The front portion 210 can have a back slot surface 218, a first side slot surface 216, a second side surface 217, and a bottom slot surface 215.

The back slot surface can extend from the shoulder surface 225, opposite to the top surface 226, towards the bottom surface 211.

The first side slot surface 216 can extend from the back slot surface 218 to the front surface 214. The first side slot surface 216 can extend from the upper surface 212 towards the bottom surface 211 in a diagonal direction relative to the front surface 214.

The second side slot surface 217 can extend from the back slot surface 218 to the front surface 214. The second side slot surface 217 can extend from the upper surface 212 towards the bottom surface 211 in a diagonal direction relative to the front surface 214. In an embodiment, the diagonal shape of the second side slot surface 217 is mirrored relative to the diagonal shape of the first side slot surface 216.

The bottom slot surface 215 can extend from the first side slot surface 216 to the second side slot surface 217, opposite from the upper surface 212. The bottom slot surface can form the adapter slot 230 with the first side slot surface 216 and second side slot surface 217.

The adapter plate can include a side surface 213 extends between the edges of front surface 214, the bottom surface 211, the shoulder surface 225, the top surface 226, and can be a surface of the front portion 210 and the back portion 220.

The adapter plate 200, can include a mounting surface 219. The mounting surface 219 can extend through the front portion 210 from the upper surface 212 to the bottom surface 211 and can be positioned to align with the mounting holes 140 of the moldboard 120. The mounting surface 219 can be configured to receive mounting fasteners 150 to connect the adapter plate 200 to the moldboard 120.

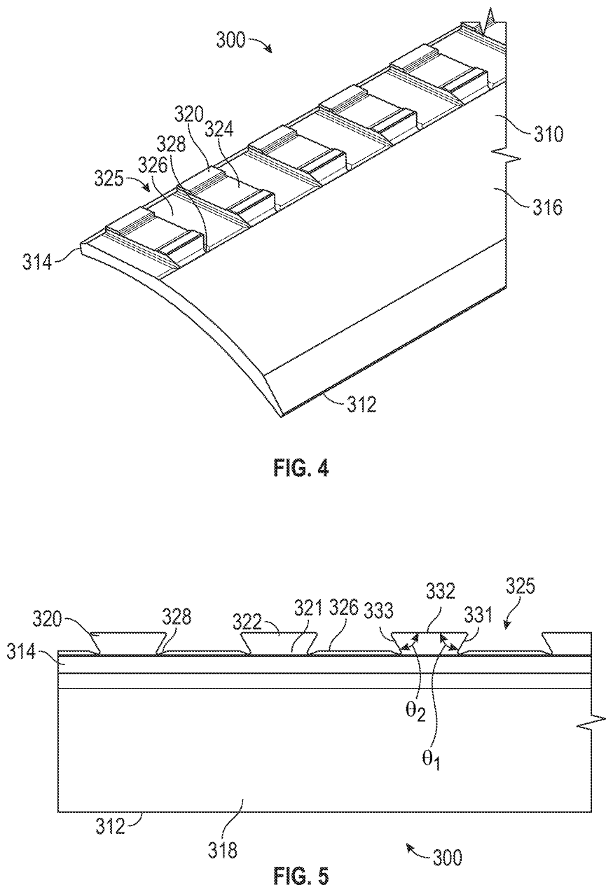

FIG. 4 is a bottom perspective view of an exemplary cutting component. In an embodiment a cutting component 300 can comprise a cutting edge. The cutting component 300 can have a body portion 310 (sometimes referred to as a body) and a series of fastening portions 320 (sometimes referred to as fasteners) extending from the body portion 310.

The body portion 310 can have a front end 312 and a back end 314 opposite the front end 312. The body portion 310 can taper proximate the front end 312. The body 310 portion can have an arcuate shape that can extend from the front end 312 to the back end 314. In an embodiment the body portion has a concave shape with respect to a plane that extends from the front end 312 to the back end 314.

The body portion can include a back surface 316 that extends from the front end 312 to the fastening portion 320.

In an embodiment the fastening portion 320 extends from the body portion 310 proximate to the back end 314. The fastening portion 320 can extend longitudinally along the body portion 310. The fastening portion 320 can have a dovetail shaped profile that extends from the back end 314 towards the front end 312. The term trapezoidal can be defined as a quadrilateral with only one pair of sustainably parallel sides. In an example the fastening portion 320 can be shaped to have a trapezoidal cross-section that extends from the back end 314 towards the front end 312. In other words, the fastener 320 can have a cross-section in the shape of a trapezoid that is oriented orthogonal to the longitudinal direction of the fastener 320. In further detail the short side of the parallel sides can be the intersection between the fastening portion 320 and the body portion 310.

The fastening portion 320 can have a fastening portion slot 324 located opposite from the body portion 310. The fastening slot 324 can form a trapezoidal like cross section that extends from the back end 314 towards the front end 312.

The fastening portions 320 of the cutting component 300 can form fastener slots 325 there between that are shaped to mate with the adapter plate 200. The cutting component 300 can include a fastening slot bottom surface 326 that extends between adjacent fastening portions 320 and extend from the back end 314 to the back surface 316. The fastening portion 320 and body portion 310 can form relief corners 328 located between the fastening slot bottom surface 326 and the fastening portion 320.

FIG. 5 is an end view of the exemplary cutting component shown in FIG. 4. The body portion 310 can have a front surface 318 opposite from the back surface 316. The front surface 318 can extend from the front end 312 to the back end 314. The relief corners 328 can extend from the back end 314 to the back surface 316. The fastening portions 320, fastening slot bottom surface 326, and relief corners 328 can form the shape of the fastener slot 324.

The fastening portion 320 can have a first portion 321 (sometimes referred to as a lower portion) located at the interface between the fastening portion 320 and the body portion 310. The fastening portion 320 can have a second portion 322 (sometimes referred to as an upper portion) that can be located further from the body portion 310 than the first portion 321. In an embodiment, the second portion 322 is located opposite from the body portion 310. The second portion 322 can be wider than the first portion 321 with respect to a direction perpendicular to the longitudinal direction of the fastening portion 320. In other words, the second portion 322 can be wider than the first portion 321 with respect to the longitudinal direction of the cutting component 300.

The fastener 320 can have a first fastener surface 331, a second fastener surface 332, and a third fastener surface 333 that together, extending around the perimeter of the fastener's 320 cross-section shown on FIG. 5. In an embodiment the first fastener surface 331 extends from the body portion 310 to the opposite end of the fastener 320. The first fastener surface 331 can extend from the first portion 321 to the second portion 322.

The second fastener surface 332 can extend from the first fastener surface 331 at an acute angle θ1. In an embodiment, angle θ1 can measure within the range of 30 to 80 degrees. The second fastener surface 332 can be proximate the second portion 322. In some embodiments the second fastener surface 332 can be a surface of the second portion 322.

The third fastener surface 333 can extend from the second fastener surface 332 at an acute angle θ2. In an embodiment, angle θ2 can measure within the range of 30 to 80 degrees. The third fastener surface 333 can extend from the first portion 321 to the second portion 322.

In an embodiment the second fastener surface 332 can be oriented approximately parallel with the fastening slot bottom surface 326. The first fastener surface 331 can extend diagonally relative to and from the second fastener surface 332. Similarly, the third fastener surface 333 can extend diagonally relative to and from the second fastener surface 332. The relief corners 328 located between adjacent fastening portions 320 and located at the intersection of the first portion 321 and the body portion 310.

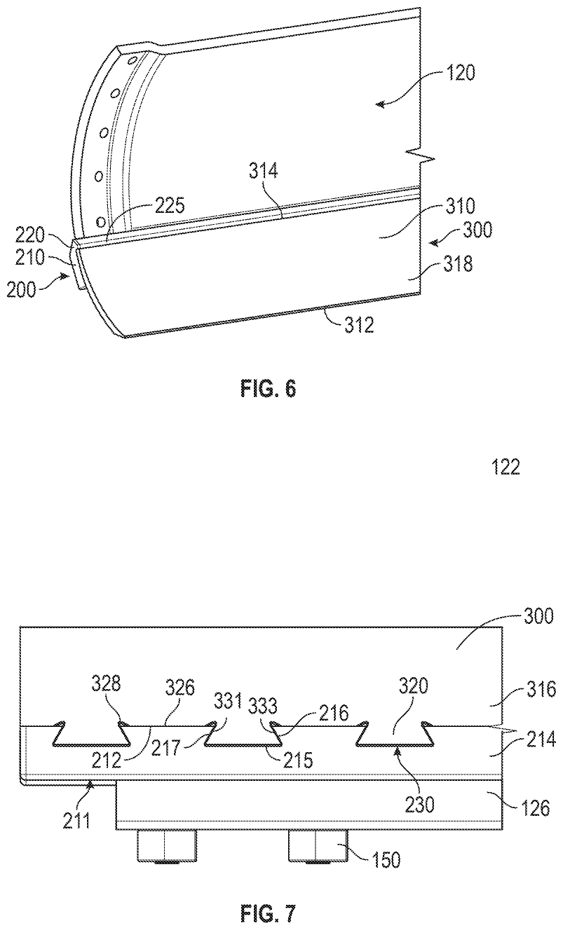

FIG. 6 is a perspective view of the cutting component of FIG. 4 mated with the adapter plate of FIGS. 2 and 3. The cutting component 300 can slidably mate with the adapter plate 200 mounted to the moldboard 120 such that the back end 314 is adjacent to the shoulder surface 225 of the back portion 220 of the adapter plate 200. The cutting component 300 can have a cutting portion 319 located at the front end 312 of the cutting component 300. The fastening portion 320 (shown on FIGS. 4 and 5) can be located at the opposite end and opposite surface from the cutting portion 319.

FIG. 7 is a front view of the cutting component mated with the adapter board from FIG. 6. The fastening portion 320 can be shaped to mate with the adapter slots 230 of the adapter plate 200. The upper surface 212, the first side slot surface 216, and the second side slot surface 217 of the adapter plate 200 can be shaped to mate with the fastener slots 325 (shown in FIGS. 4 and 5). The first fastener surface 331 can be positioned to contact the second side slot surface 217. The second fastener surface 332 can be positioned proximate the bottom slot surface 215. The third fastener surface 333 can be positioned to contact the first side slot surface 216. The fastening slot bottom surface 326 can be positioned to contact the upper surface 212. In an embodiment, the first fastener surface 331 and the third fastener surface 333 are arranged to simultaneously contact the second side slot surface 217 and first side slot surface 216 respectively, if the cutting component 300 is mated with the adapter plate 200.

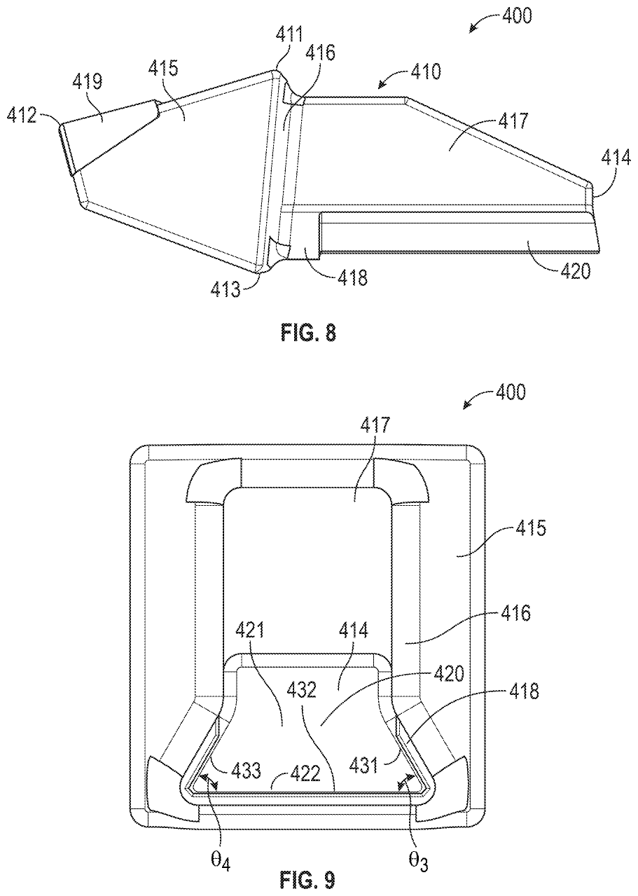

FIG. 8 is a side view of another cutting component. In an embodiment a cutting component 400 can comprise a cutting bit. The cutting component 400 can have a body portion 410 (sometimes referred to as a body) and a fastening portion 420 (sometimes referred to as a fastener) extending from the body portion 410.

The body portion 410 can have a front end 412 and a back end 414 opposite the front end 412. The body portion 410 can have a front portion 415, a transition portion 416, and a back portion 417.

The front portion 415 can have a tapered shape, expanding as it extends from the front end 412 towards the back end 414. The front portion 415 can have a cutting portion 419 located proximate to the front end 412. The cutting portion 419 can be configured to engage with and displace working material such as soil, rock, sand, debris, brush, garbage, other moveable material. The front end 412 can have a top end 411 and a bottom end 413 opposite the top end 411. The top end 411 and the bottom end 413 can be located where the front portion 415 is largest.

The back portion 417 can have a tapered shape, widens as it extends from the back end 414 towards the front end 412, reaching a point where the widening stop and the back portion extends towards the front end 412 while maintaining its shape.

The transition portion 416 can extend from the back portion 417 to the front portion 415. In an embodiment, the transition portion 416 transitions from the smaller dimensions of the back portion 417 to the larger dimensions of the front portion 415.

The body portion 410 can include a shoulder portion 418. The shoulder portion 418 can be located proximate to the bottom end 413. The shoulder portion 418 can extend from the back portion 417 towards the bottom end 413. The shoulder portion 418 can extend from the transition portion 416 towards the back end 414.

In an embodiment the fastening portion 420 extends from the back portion 417 towards the bottom end 413. The fastening portion 420 can extend longitudinally from the shoulder portion 418 to the back end 414. In an embodiment the fastening portion 420 extends past the back end 414. The fastening portion 420 can be positioned opposite from the cutting portion 419.

FIG. 9 is a back view of the cutting component from FIG. 8. The fastening portion 420 can have a dovetail shaped profile that extends from the shoulder portion 418 towards the back end 414. In an example the fastening portion 420 can be shaped as a trapezoidal cross-section that extends from proximate the shoulder portion 418 towards the back end 414. In other words, the fastening portion 420 can be shaped as a trapezoidal cross-section that extends from the back end 414 towards the front end 412. In other words, the fastener 420 can have a cross-section in the shape of a trapezoid that is oriented orthogonal to the longitudinal direction of the fastener 420.

In further detail the short side of the parallel sides can be the intersection between the fastening portion 420 and the back portion 417 of the body portion 410.

The fastening portion 420 can have a first portion 421 located at the interface between the fastening portion 420 and the body portion 410. The fastening portion 420 can have a second portion 422 that can be located further from the body portion 410 than the first portion 421. In an embodiment, the second portion 422 is located opposite from the body portion 410. The second portion 422 can be wider than the first portion 421 with respect to a direction perpendicular to the longitudinal direction of the fastening portion 420. In other words, the second portion 422 can be wider than the first portion 421 with respect to a plane perpendicular the longitudinal direction of the cutting component 400.

The fastener 420 can have a first fastener surface 431, a second fastener surface 432, and a third fastener surface 433 that together, extending around the perimeter of the fastener 420. In an embodiment the first fastener surface 431 extends from the body portion 410 to the opposite end of the fastener 420. The first fastener surface 431 can extend from the first portion 421 to the second portion 422.

The second fastener surface 432 can extend from the first fastener surface 431 at an acute angle θ3. In an embodiment, angle θ3 can measure within the range of 30 to 80 degrees. The second fastener surface 432 can be proximate the second portion 422. In some embodiments the second fastener surface 432 can be a surface of the second portion 422.

The third fastener surface 433 can extend from the second fastener surface 432 at an acute angle θ4. In an embodiment, angle θ4 can measure within the range of 30 to 80 degrees. The third fastener surface 433 can extend from the first portion 421 to the second portion 422.

In an embodiment the second fastener surface 432 can be oriented approximately parallel with the fastening slot bottom surface 426. The first fastener surface 431 can extend diagonally relative to and from the second fastener surface 432. Similarly, the third fastener surface 433 can extend diagonally relative to and from the second fastener surface 432.

In an embodiment the shoulder portion 418 can extend around the perimeter of the fastening portion 420.

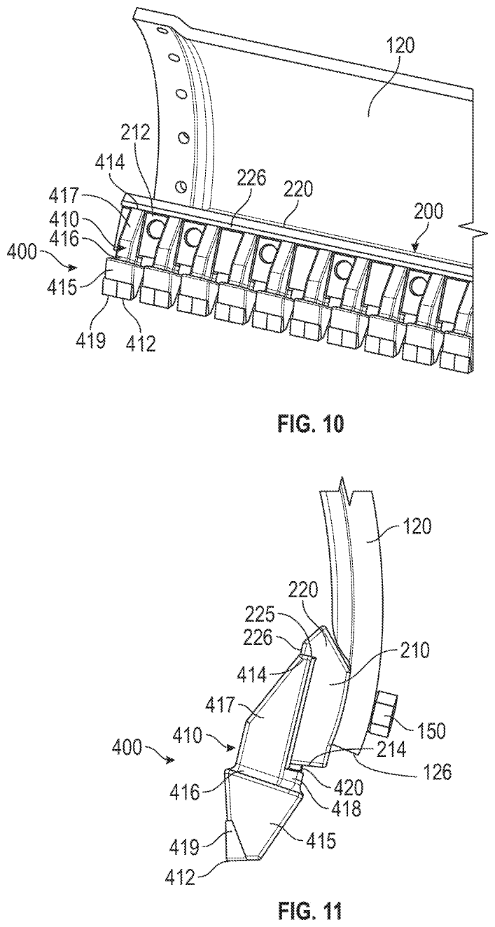

FIG. 10 is a perspective view of the cutting component of FIG. 8 mated with the adapter plate of FIGS. 2 and 3. The cutting component 400 can slidably mate with the adapter plate 200 mounted to the moldboard 120 such that the back end 414 is proximate to the top surface 226 of the back portion 220 of the adapter plate 200. The cutting component 400 can have the cutting portion 419 opposite from the back portion 220 of the adapter plate 200.

Though not shown, the first fastener surface 431 can be positioned to contact the second side slot surface 217. The second fastener surface 432 can be positioned proximate the bottom slot surface 215. The third fastener surface 433 can be positioned to contact the first side slot surface 216.

FIG. 11 is a side view of the cutting component of FIG. 8 mated with the adapter plate of FIGS. 2 and 3. In the embodiment, the cutting component 400 is slidably mated with the adapter plate 200 such that the back end 414 is adjacent to the shoulder surface 225 of the adapter plate 200. The shoulder portion 418 can be positioned proximate to the front surface 214 of the adapter plate 200 while the fastening portion 420 is mated with the adapter slots (shown on FIG. 3) of the adapter plate 200.

### INDUSTRIAL APPLICABILITY

The present disclosure generally applies to a cutting component 300, 400 for a machine 10. It is understood that the cutting component 300, 400 may be used with any stationary or mobile machine known in the art. Such machines may be used in construction, farming, mining, power generation, and/or other like applications. Accordingly, such machines may include, for example, excavators, track-type tractors, wheel loaders, on-road vehicles, off-road vehicles, generator sets, motor graders, or other like machines.

To increase the longevity or the usable life of the moldboard 120, one or more cutting components 300,400 formed of an alloy of metallic ground engaging materials can attached to the ground engaging or lower edge of the moldboard 120. The cutting components 300, 400 may be replaceable. As should be understood by those having ordinary skill in the art, cutting component 300, 400 materials generally have a hardness and an abrasive wear resistance, which are harder and more durable than materials used in forming non-wear portions of the moldboard 120.

Though cutting components 300, 400 are designed and manufactured for longevity, they eventually wear out and require replacement. It can be very time consuming to bolt on cutting components such as a cutting edge or multiple cutting bits, and can lead to a loss of working time. A cutting component 300, 400 with a different shape and configuration can be installed faster.

The cutting component 300, 400 can be shaped and configured to mate with the adapter plate 200 without the need of a bolt. The cutting component 300, 400, can have a fastening portion(s) 320, 420 that can slide into the adapter slot(s) 230 of the adapter plate 200. The shape of the fastening portion 320, 420 can contact the first side slot surface 216 and second side surface 217 of the adapter plate 200 to resist horizontal forces/loads experienced, for example, by scraping the ground during ground engaging activities. A portion of the fastening portion 320, 420 adjacent to the back end 414 can contact the back slot surface 218 to resist vertical forces/loads experienced, for example, by impacting the ground during ground engagement activities. Similarly, the back end 414 can contact the shoulder surface 225 of the back portion 220 to resist forces/loads experienced, for example, by impacting the ground during ground engagement activities. In another example, the adapter slots 230 can be tapered, such that the adapter slots 230 are wider adjacent then front surface 214 than away from the front surface 214. The tapered shape of the adapter slots 230 can be used to contact the fastening portion 320, 420 of the cutting components 300, 400 to resist impacting loads pushing upwards against the cutting components 300, 400.

Though not shown a fastening system can be used to prevent the cutting component 300, 400 from disengaging from the adapter plate 200 and for example, resist relatively small loads such as gravity loads. In an example the fastening system can comprise pins, latches, retention buttons, or other low load retention fastening systems.

Although this invention has been shown and described with respect to detailed embodiments thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of machine 10. For example, the described embodiments may be applied to machines employed in mining, construction, farming, and power generation applications, or any variant thereof. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

It will be understood that the benefits and advantages described above may relate to one embodiment or may relate to several embodiments. The embodiments are not limited to those that have any or all of the stated benefits and advantages.

What is claimed is:

1. A cutting component for a ground engaging machine including a moldboard with a first end, and an adapter plate mounted to the moldboard proximate the first end, the adapter plate having an adapter slot, the cutting component comprising:
a body having
a cutting portion configured to engage a working material; and
a fastener extending from the body and extending longitudinally along the body, the fastener shaped to slidably mate with the adapter slot of the adapter plate, the fastener including
an upper portion located at an interface between the body and the fastener, and
a lower portion located further from the body than the upper portion, the lower portion shaped wider than the upper portion with respect to a direction that is perpendicular to the longitudinal direction of the fastener.

2. The cutting component of claim 1, wherein the cutting component is a cutting edge.

3. The cutting component of claim 2, wherein the cutting component has a plurality of fasteners, the plurality of fasteners forming fastener slots there between shaped to mate with the adapter plate.

4. The cutting component of claim 3, wherein the plurality of fasteners form relief corners located between adjacent fasteners and located at the intersection of the upper portion and the body.

5. The cutting component of claim 3, wherein the body includes a front end and a back end opposite the front end, the front end shaped to contact the adapter plate if the cutting component is matted with the adapter plate.

6. The cutting component of claim 5, wherein the plurality of fasteners extend from the back end towards the front end.

7. The cutting component of claim 1, wherein the cutting component is a cutting bit.

8. A cutting component for a ground engaging machine with an adapter plate having a first side slot surface and second side slot surface, the cutting component comprising:
a body having
a cutting portion configured to engage a working material; and
a fastener located opposite from the cutting portion and extending from the body having
a first fastener surface;
a second fastener surface extending from adjacent the first fastener surface with an acute angle formed between the second fastener surface and the first fastener surface; and
a third fastener surface extending from adjacent the second fastener surface with an acute angle formed between the third fastener surface and the second fastener surface.

9. The cutting component of claim 8, wherein the cutting component is a cutting edge.

10. The cutting component of claim 9, wherein the cutting component has a plurality of fasteners, the plurality of fasteners forming fastener slots there between shaped to mate with the adapter plate.

11. The cutting component of claim 8, wherein the first fastener surface and the third fastener surface are arranged to simultaneously contact the second side slot surface and the first side slot surface respectively, if the cutting component is mated with the adapter plate.

12. The cutting component of claim 10, wherein the body includes a front end and a back end opposite the front end, the front end shaped to contact the adapter plate if the cutting component is matted with the adapter plate.

13. The cutting component of claim 12, wherein the plurality of fasteners extend from the back end towards the front end.

14. The cutting component of claim 8, wherein the cutting component is a cutting bit.

15. The cutting component of claim 8, wherein the second fastener surface extends from adjacent the first fastener surface at an angle within a range of 30 to 80 degrees and the third fastener surface extends from adjacent the second fastener surface at an angle within a range of 30 to 80 degrees.

16. A cutting component for a ground engaging machine with a moldboard having a first end and an adapter plate mounted to the moldboard, the adapter plate having an adapter slot, the cutting component comprising:
a body having
a front end,
a cutting portion proximate the front end and configured to engage working material, and
a back end opposite the front end; and
a fastener extending from the body, extending longitudinally from the back end towards the front end and having a cross section in a shape of a trapezoid orthogonal to the longitudinal direction of the fastener, the fastener configured to mate with the adapter slot of the adapter plate.

17. The cutting component of claim 16, wherein the cutting component is a cutting edge.

18. The cutting component of claim 17, wherein the cutting component has a plurality of fasteners, the plurality of fasteners forming fastener slots there between shaped to mate with the adapter plate.

19. The cutting component of claim 16, wherein the front end is shaped to contact the adapter plate if the cutting component is matted with the adapter plate.

20. The cutting component of claim 16, wherein the cutting component is a cutting bit.
